(19) United States
(12) Patent Application Publication
(10) Pub. No.: US 2024/0116740 A1
(43) Pub. Date: Apr. 11, 2024

(54) REMOVABLE PRY BAR HEEL

(71) Applicant: Todd Schulze, Vero Beach, FL (US)

(72) Inventor: Todd Schulze, Vero Beach, FL (US)

(21) Appl. No.: 17/938,867

(22) Filed: Oct. 7, 2022

(51) Int. Cl. B66F 15/00

(52) U.S. Cl. CPC B66F 15/00

(57) ABSTRACT

An apparatus for adjusting the fulcrum point on a pry bar including a concave surface; a convex surface opposing the concave surface; a first planar surface having a first edge secured to an entirety of a first edge of the concave surface and a second edge secured to an entirety of a first edge of the convex surface; a second planar surface, parallel to the first planar surface and having a first edge secured to an entirety of a second edge of the concave surface and a second edge secured to an entirety of a second edge of the convex surface; and a securing member carried by the concave surface and adapted to removably secure to the pry bar.

### FIELD OF THE INVENTION

The present invention relates to a system for adjusting the fulcrum point of a pry bar. More specifically, the present invention is directed to an apparatus removably secured to a pry bar to position the fulcrum point further away from the load.

### BACKGROUND OF THE INVENTION

Known pry bars include a load arm and an effort arm with a fulcrum positioned between the two. The fulcrum point of known pry bars is fixed. What is needed is an apparatus that may be secured to a known pry bar to change the location of the fulcrum point, thereby decreasing the amount of effort needed to move the load.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to an apparatus for adjusting the fulcrum point on a pry bar including a concave surface, a convex surface opposing the concave surface, a first planar surface, a second planar surface, and a securing member.

The first planar surface may have a first edge secured to an entirety of a first edge of the concave surface and a second edge secured to an entirety of a first edge of the convex surface.

The second planar surface may be parallel to the first planar surface and have a first edge secured to an entirety of a second edge of the concave surface and a second edge secured to an entirety of a second edge of the convex surface.

The securing member may be carried by the concave surface and adapted to removably secure to the pry bar.

The securing member may include or may be a magnet.

The concave surface may include a recess adapted to carry the magnet or other securing member. The recess may have an outer circumference greater than an outer circumference of the magnet or other securing member and the magnet or other securing member may be positioned within the outer circumference of the recess. The magnet or other securing member may include a central securing aperture.

A fastening member may be carried by the central securing aperture of the securing member and may be adapted to pivotally secure the magnet or other securing member to a surface of the recess.

In one embodiment, the apparatus may include a plurality of securing members adapted to removably secure to the pry bar.

The concave surface may further include a plurality of recesses wherein each of the plurality of recesses may be adapted to carry one of the plurality of securing members.

The first curvature, which may be defined by of the concave surface, may not be the same as a second curvature, which may be defined by the convex surface.

A front device edge may be the same as the front edge of the concave surface and the front edge of the convex surface.

The rear device edge may be the same as the rear edge of the concave surface and the rear edge of the convex surface.

The front device edge may be a front edge of the concave surface and a front edge of the convex surface. The rear device edge may be a rear edge of the concave surface and a rear edge of the convex surface. And the center of mass of the apparatus may be positioned closer to the rear device edge than the front device edge.

The concave surface may have a first curvature, a first edge connecting a front edge and a rear edge, and a second edge connecting the front edge and the rear edge.

The convex surface may have a second curvature, a first edge connecting a front edge and a rear edge, and a second edge connecting the front edge and the rear edge.

The first planar surface may have a first edge secured to an entirety of the first edge of the concave surface and a second edge secured to an entirety of the first edge of the convex surface.

The second planar surface, which may be parallel to the first planar surface, may have a first edge secured to an entirety of the second edge of the concave surface and a second edge secured to an entirety of the second edge of the convex surface.

The first curvature may not be equal to the second curvature.

The concave surface may include a first curvature, a first edge connecting a front edge and a rear edge, a second edge connecting the front edge and the rear edge, and an annular recess having an outer circumference.

The convex surface may include a second curvature, a first edge connecting a front edge and a rear edge, and a second edge connecting the front edge and the rear edge.

The first planar surface may include a first edge secured to an entirety of the first edge of the concave surface, and a second edge secured to an entirety of the first edge of the convex surface.

The second planar surface, which may be parallel to the first planar surface, may include a first edge secured to an entirety of the second edge of the concave surface, and a second edge secured to an entirety of the second edge of the convex surface.

The magnet may have an outer circumference less than the outer circumference of the annular recess, may be carried by the annular recess, and may be adapted to removably secure to the pry bar.

### BRIEF DESCRIPTION OF THE DRAWINGS

Some embodiments of the present invention are illustrated as an example and are not limited by the figures of the accompanying drawings, in which like references may indicate similar elements.

FIG. 1 perspective view of an apparatus for adjusting the fulcrum point on a pry bar according to an embodiment of the present invention, in combination with a pry bar.

FIG. 2 is a perspective first side view of the apparatus for adjusting the fulcrum point on a pry bar of FIG. 1.

FIG. 3 is a perspective second side view of the apparatus for adjusting the fulcrum point on a pry bar of FIG. 1.

FIG. 4 top plan view of the apparatus for adjusting the fulcrum point on a pry bar of FIG. 1.

FIG. 5 is a bottom plan view of the apparatus for adjusting the fulcrum point on a pry bar of FIG. 1.

FIG. 6 is a front elevation view of the apparatus for adjusting the fulcrum point on a pry bar of FIG. 1.

FIG. 7 is a rear elevation view of the apparatus for adjusting the fulcrum point on a pry bar of FIG. 1.

FIG. 8 is a side elevation view of the apparatus for adjusting the fulcrum point on a pry bar of FIG. 1.

FIG. 9 is a top plan view of a securing member of the apparatus of FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

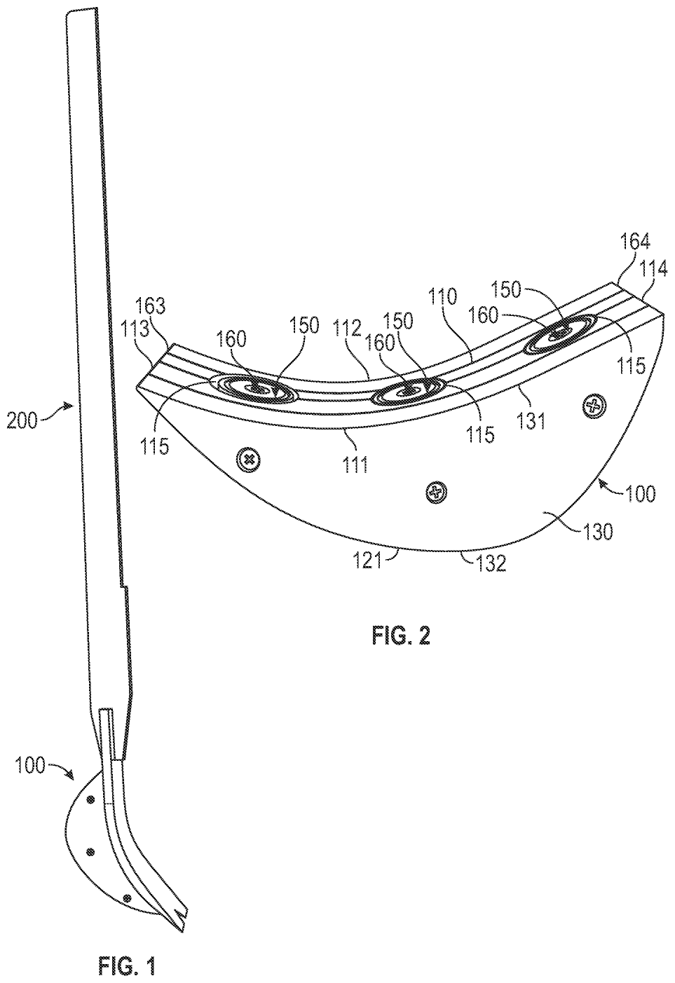

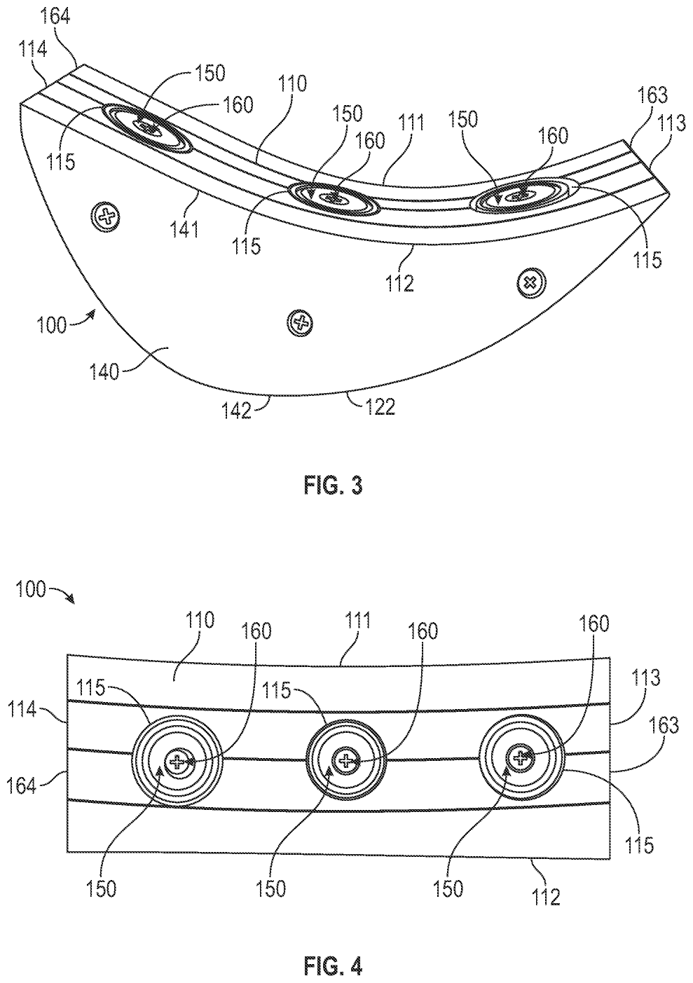

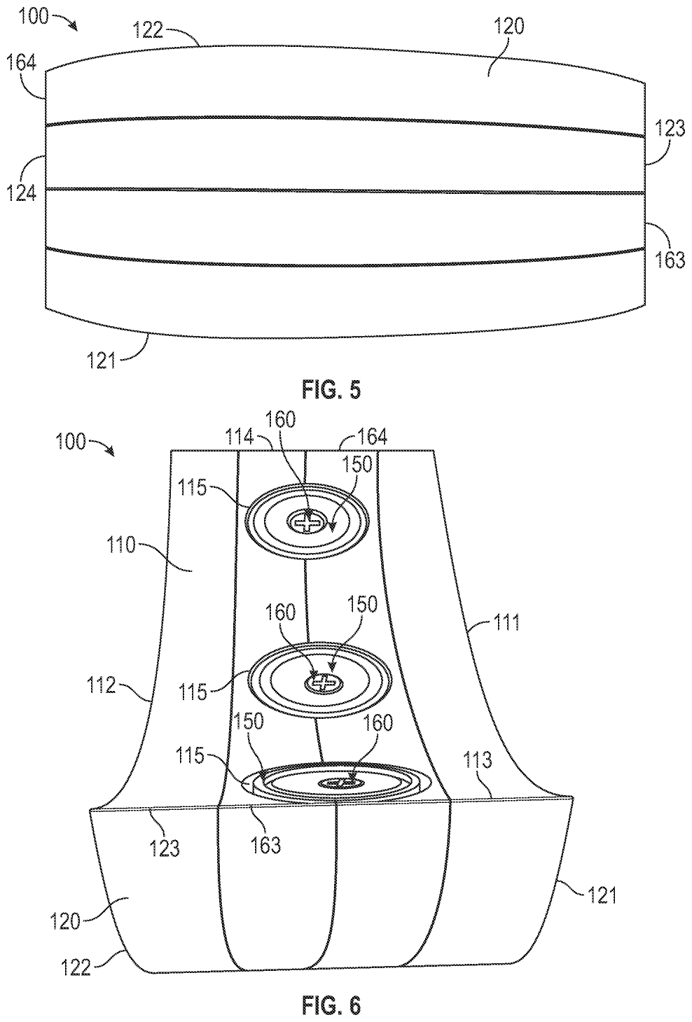

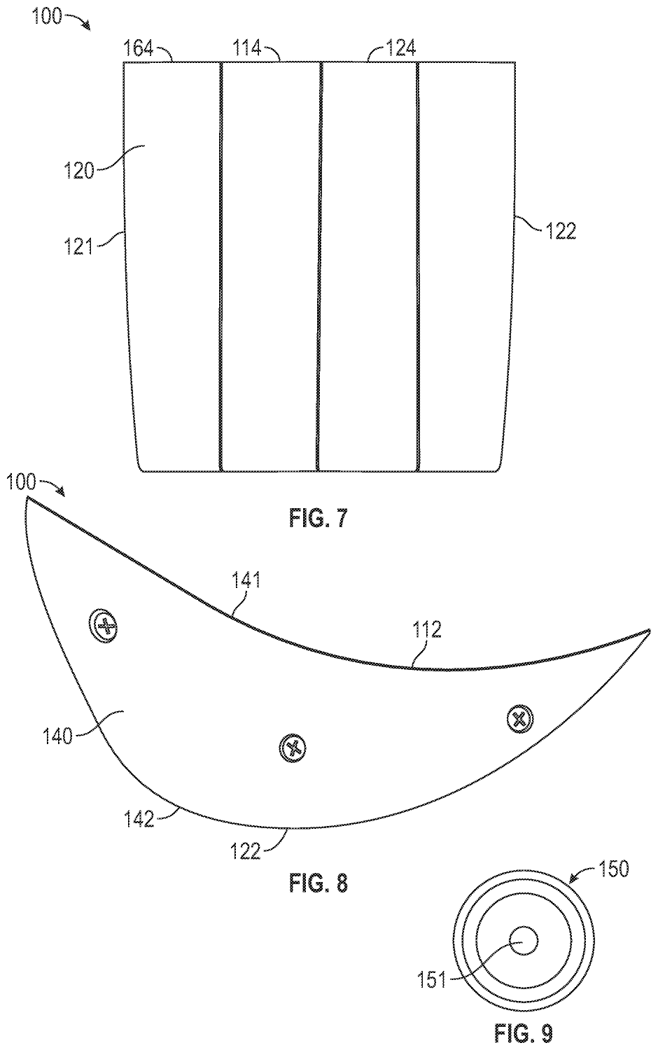

An embodiment of the invention, as shown and described by the various figures and accompanying text, provides an apparatus for adjusting the fulcrum point on a pry bar 100. FIG. 1 depicts the apparatus 100 in combination with a pry bar 200. FIG. 3 depicts the apparatus 100 removed from the pry bar 200 and FIG. 2 depicts the pry bar 200 alone.

The apparatus 100 may be removably secured to the pry bar 200 to make the pry bar 200 a more versatile tool. When the apparatus 100 is secured to the pry bar 200, a user may more easily lift concrete forms and other heavy items using the combination pry bar 200 and apparatus 100.

The apparatus 100 may have a concave surface 110. The curvature of the concave surface 110 may match the curvature of a rear surface of the pry bar 200. When secured to the pry bar 200, the concave surface 110 may abut a rear surface of the pry bar 200 along an entirety of a length of the concave surface 110. The concave surface 110 may have a first edge 111 parallel to and opposing a second edge 112 along an entirety of the length of the concave surface 110. The concave surface 110 may also have a front edge 113 and a rear edge 114. The first edge 111 may directly connect to the front edge 113 at a first end and to the rear edge 114 at a second end. The second edge 112 may directly connect to the front edge 113 at a first end and to the rear edge 114 at a second end. The front edge 113 and the rear edge 114 may be parallel to one another.

The apparatus 100 may have a convex surface 120. The convex surface 120 may oppose the concave surface 110. The curvature of the convex surface 120 may be different than the curvature of a concave surface 110. When secured to the pry bar 200, the convex surface 120 may be distal the pry bar 200 and adjacent a surface upon which the apparatus 100 may form a fulcrum for the pry bar 200. The convex surface 120 may have a first edge 121 parallel to and opposing a second edge 122 along an entirety of the length of the convex surface 120. The convex surface 120 may also have a front edge 123 and a rear edge 124. The first edge 121 may directly connect to the front edge 123 at a first end and to the rear edge 124 at a second end. The second edge 122 may directly connect to the front edge 123 at a first end and to the rear edge 124 at a second end. The front edge 123 and the rear edge 124 may be parallel to one another.

The apparatus 100 may also have a first planar surface 130 secured directly to the first edge 111 of the concave surface 110 and the first edge 121 of the convex surface 120. A first edge 131 of the first planar surface 130 may directly adjoin the first edge 111 of the concave surface 110 along an entirety of a length of both the first edge 111 of the concave surface 110 and the first edge 131 of the first planar surface 130. A second edge 132 of the first planar surface 130 may directly adjoin the first edge 121 of the convex surface 120 along an entirety of a length of both the first edge 121 of the convex surface 120 and the second edge 132 of the first planar surface 130. The first edge 131 of the first planar surface 130 may define the first curvature of the concave surface 110. The second edge 132 of the first planar surface 130 may define the second curvature of the convex surface 120. The first edge 131 of the first planar surface 130 may connect directly to the second edge 132 of the first planar surface 130 at both a front and a rear of the first planar surface 130.

The front edge 113 of the concave surface 110 may also form the front edge 123 of the convex surface 120 and define the front device edge 163. The rear edge 114 of the concave surface 110 may also form the rear edge 124 of the convex surface 120 and define the rear device edge 164.

The apparatus 100 may also have a second planar surface 140 secured directly to the second edge 112 of the concave surface 110 and the second edge 122 of the convex surface 120. The second planar surface 140 may be parallel to the first planar surface 130. A first edge 141 of the second planar surface 140 may directly adjoin the second edge 112 of the concave surface 110 along an entirety of a length of both the second edge 112 of the concave surface 110 and the first edge 141 of the second planar surface 140. A second edge 142 of the second planar surface 140 may directly adjoin the second edge 122 of the convex surface 120 along an entirety of a length of both the second edge 122 of the convex surface 120 and the second edge 142 of the second planar surface 140. The first edge 141 of the second planar surface 140 may define the first curvature of the concave surface 110. The second edge 142 of the second planar surface 140 may define the second curvature of the convex surface 120. The first edge 141 of the second planar surface 140 may connect directly to the second edge 142 of the second planar surface 140 at both a front and a rear of the second planar surface 140.

The first and second curvatures may not be arcuate. For each of the first and second curvatures, the radius of curvature may vary along the length of the surface. The first curvature may be defined by the concave surface 110 and may not be the same as the second curvature, which is defined by the convex surface 120. The distance between the concave surface 110 and the convex surface 120 may increase toward the middle of the apparatus 110 and there may be greater separation between the concave surface 110 and the convex surface 120 as the distance from the front device edge 163 increases until a maximum separation point is reached between the front device edge 163 and the rear device edge 164. The distance between the concave surface 110 and the convex surface 120 may increase as the distance from the rear device edge 164 increases until the maximum separation point is reached. The maximum separation point may be positioned closer to the rear device edge 164 than the front device edge 163. This configuration and relative spacing between the concave surface 110 and the convex surface 120 may result in the center of mass of the apparatus 100 being positioned closer to the rear device edge 164 than to the front device edge 163.

A securing member 150 may be carried by the concave surface 110. The securing member may be adapted to removably secure the apparatus 100 to the pry bar 200. The securing member may be a clamp, one half of a hooks and loop fastener, one half of a snap, a magnet, or the like. The concave surface 110 may include a recess 115 adapted to carry the securing member 150. The recess 115 may have dimensions greater than the size of the securing member 150. The securing member 150 may be carried entirely within the recess 115. In one embodiment, both recess 115 and the securing member 150, which may be a magnet, may be circular. The recess 115 may have an outer circumference that is greater than the outer circumference of the magnet. Such a configuration may allow the securing member 150 to be positioned entirely within the outer circumference of the recess 115. The minimum depth of the recess 115 may be equal to or greater than the thickness of the securing member 150. The maximum depth of the recess 115 may be greater than the thickness of the securing member 150. The depth of the recess 155, as measured from the outermost surface of the concave surface 110, may be greater around the edges of the recess 155 than at the center point of the recess 155. The securing member 150, including, but not limited to, a magnet, may include a central securing aperture 151. The central securing aperture 151 may be configured to carry a fastening member 160, including, but not limited to, a screw, nail, rivet, or the like. The central securing aperture 151 may be arcuate and extend through an entirety of the thickness of the securing member 150 from a first side to a second side. The central securing aperture 150 may be positioned at the center point of the securing member 150. Such a configuration may allow the securing member 150 to pivot about the fastening member 160. In such an embodiment, the central securing aperture 151 may carry the fastening member 160, which may pivotally secure the securing member 150 to a surface within the recess 115.

In one embodiment, there may be a plurality of securing members 150 adapted to removably secure to the pry bar 200. The securing members 150 may be of identical or different types than other securing members 150.

There may be a plurality of recesses 115 within the concave surface 110. Each of the recesses 115 may be adapted to carry one of the plurality of securing members 150. All of the recesses 115 and the securing members 150 may be annular. In one embodiment, there may be three recesses 115 in the concave surface 110. The center points of the three recesses 150 may form a line normal to the front device edge 163 and the rear device edge 164. A central recess 115 may be equidistant from each of a front recess 115 and a rear recess 115. Each of the three recesses 115 may carry a corresponding securing member 150.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. An apparatus for adjusting the fulcrum point on a pry bar comprising:
a concave surface;
a convex surface opposing the concave surface;
a first planar surface having a first edge secured to an entirety of a first edge of the concave surface and a second edge secured to an entirety of a first edge of the convex surface;
a second planar surface, parallel to the first planar surface and having a first edge secured to an entirety of a second edge of the concave surface and a second edge secured to an entirety of a second edge of the convex surface; and
a securing member carried by the concave surface and adapted to removably secure to the pry bar.

2. The apparatus of claim 1 wherein the securing member further comprises a magnet.

3. The apparatus of claim 2 wherein the concave surface further comprises a recess adapted to carry the magnet.

4. The apparatus of claim 3 wherein the recess has an outer circumference greater than an outer circumference of the magnet and the magnet is positioned within the outer circumference of the recess.

5. The apparatus of claim 4 wherein the magnet comprises a central securing aperture.

6. The apparatus of claim 5 further comprising a fastening member carried by the central securing aperture and adapted to pivotally secure the magnet to a surface of the recess.

7. The apparatus of claim 1 further comprising a plurality of securing members adapted to removably secure to the pry bar.

8. The apparatus of claim 7 wherein the concave surface further comprises a plurality of recesses wherein each of the plurality of recesses is adapted to carry one of the plurality of securing members.

9. The apparatus of claim 1 wherein a first curvature defined by of the concave surface is not the same as a second curvature defined by the convex surface.

10. The apparatus of claim 1 wherein a front device edge is a front edge of the concave surface and a front edge of the convex surface.

11. The apparatus of claim 1 wherein a rear device edge is a rear edge of the concave surface and a rear edge of the convex surface.

12. The apparatus of claim 1 wherein a front device edge is a front edge of the concave surface and a front edge of the convex surface, wherein a rear device edge is a rear edge of the concave surface and a rear edge of the convex surface, and wherein a center of mass of the apparatus is positioned closer to the rear device edge than the front device edge.

13. An apparatus for adjusting the fulcrum point on a pry bar comprising:
a concave surface having a first curvature, a first edge connecting a front edge and a rear edge, and a second edge connecting the front edge and the rear edge;
a convex surface having a second curvature, a first edge connecting a front edge and a rear edge, and a second edge connecting the front edge and the rear edge;
a first planar surface having a first edge secured to an entirety of the first edge of the concave surface and a second edge secured to an entirety of the first edge of the convex surface;
a second planar surface, parallel to the first planar surface and having a first edge secured to an entirety of the second edge of the concave surface and a second edge secured to an entirety of the second edge of the convex surface; and
a securing member carried by the concave surface and adapted to removably secure to the pry bar; and
wherein the first curvature is not equal to the second curvature.

14. The apparatus of claim 13 wherein the securing member further comprises a magnet.

15. The apparatus of claim 14 wherein the concave surface further comprises a recess adapted to carry the magnet.

16. The apparatus of claim 15 wherein the recess has an outer circumference greater than an outer circumference of the magnet and the magnet is positioned within the outer circumference of the recess.

17. The apparatus of claim 13 wherein a front device edge is a front edge of the concave surface and a front edge of the convex surface.

18. The apparatus of claim 13 wherein a rear device edge is a rear edge of the concave surface and a rear edge of the convex surface.

19. The apparatus of claim 13 wherein a front device edge is a front edge of the concave surface and a front edge of the convex surface, wherein a rear device edge is a rear edge of the concave surface and a rear edge of the convex surface, and wherein a center of mass of the apparatus is positioned closer to the rear device edge than the front device edge.

20. An apparatus for adjusting the fulcrum point on a pry bar comprising:
a concave surface comprising:
a first curvature,
a first edge connecting a front edge and a rear edge,
a second edge connecting the front edge and the rear edge, and
an annular recess having an outer circumference;
a convex surface comprising:
a second curvature,
a first edge connecting a front edge and a rear edge, and
a second edge connecting the front edge and the rear edge;
a first planar surface comprising:
a first edge secured to an entirety of the first edge of the concave surface, and
a second edge secured to an entirety of the first edge of the convex surface;
a second planar surface, parallel to the first planar surface, and comprising:
a first edge secured to an entirety of the second edge of the concave surface, and
a second edge secured to an entirety of the second edge of the convex surface; and
a magnet having an outer circumference less than the outer circumference of the annular recess, carried by the annular recess, and adapted to removably secure to the pry bar;
wherein the first curvature is not equal to the second curvature;
wherein a front device edge is the front edge of the concave surface and the front edge of the convex surface
wherein a rear device edge is the rear edge of the concave surface and the rear edge of the convex surface; and
wherein a center of mass of the apparatus is positioned closer to the rear device edge than the front device edge.
